(19) United States
(12) Patent Application Publication
(10) Pub. No.: US 2019/0069006 A1
(43) Pub. Date: Feb. 28, 2019

(54) SEEKING IN LIVE-TRANSCODED VIDEOS

(71) Applicant: Western Digital Technologies, Inc., San Jose, CA (US)

(72) Inventor: Sailesh RACHABATHUNI, Santa Clara, CA (US)

(21) Appl. No.: 15/689,631

(22) Filed: Aug. 29, 2017

(51) Int. Cl. H04N 21/2343; H04N 21/472; H04N 21/845; H04N 21/2747; H04N 21/239

(52) U.S. Cl. CPC H04N 21/234336; H04N 21/47217; H04N 21/2393; H04N 21/2747; H04N 21/8456

(57) ABSTRACT

Systems and methods for implementing seeking functionality in a live-transcoding environment provide a computing device that includes input/output (I/O) circuitry, a memory module storing a media player program, and control circuitry. The control circuitry is configured to connect to a data storage server over a network connection, send a first request to the data storage server for a video file, the first request including a first timestamp parameter, receive a first transcoded video stream from the server, present the first transcoded video stream and a video presentation interface associated with the media player program to a user, present a custom seek bar to the user, receive seeking input associated with the custom seek bar, the seeking input indicating a second time associated with the video file, and send a second request to the data storage server for the video file including a second timestamp parameter indicating the second time.

### BACKGROUND

### Field

This disclosure relates to data storage systems. More particularly, the disclosure relates to systems and methods for implementing seeking in live-transcoded video streams.

### Description of Related Art

Video containers and streams may be maintained in formats that are incompatible with certain client(s) that may wish to access them. In order to provide format compatibility, transcoding may be implemented at a data storage server. However, seeking within a video stream that is live-transcoded can present certain issues.

### BRIEF DESCRIPTION OF THE DRAWINGS

Various embodiments are depicted in the accompanying drawings for illustrative purposes, and should in no way be interpreted as limiting the scope of this disclosure. In addition, various features of different disclosed embodiments can be combined to form additional embodiments, which are part of this disclosure.

FIG. 1 is a diagram of a networked data storage system in accordance with one or more embodiments.

FIG. 2 is a block diagram of a data storage server system in accordance with one or more embodiments.

FIG. 3 illustrates an example video interface in accordance with one or more embodiments.

FIG. 4 illustrates a sequence diagram for implementing live transcoding with seeking functionality in accordance with one or more embodiments.

FIG. 5 is a flow diagram illustrating a process for implementing seeking in a live-transcoding environment in accordance with one or more embodiments.

FIG. 6 is a flow diagram illustrating a process for implementing seeking in a live-transcoding environment in accordance with one or more embodiments.

### DETAILED DESCRIPTION

While certain embodiments are described, these embodiments are presented by way of example only, and are not intended to limit the scope of protection. Indeed, the novel methods and systems described herein may be embodied in a variety of other forms. Furthermore, various omissions, substitutions and changes in the form of the methods and systems described herein may be made without departing from the scope of protection.

### Overview

Disclosed herein are systems, devices, and methods for implementing seeking functionality with respect to live-transcoded video streams. For example, such transcoded video streams may be provided by a data storage server to a client device or system communicatively connected thereto. Although certain embodiments are disclosed herein in the context of data storage servers, and in particular network-attached storage devices (NAS) and systems, it should be understood that the principles disclosed herein may be applicable in other environments wherein transcoding of video, audio, or other data or content is desired.

Certain data storage systems may include a data storage server connected to a client. For example, a data storage system may include a home-storage NAS device, on which a user can store his or her video/audio content and get access to the same using certain software clients provided in connection with the NAS and/or compatible therewith. Although certain embodiments are disclosed herein in the context of video files and video content, it should be understood that principles disclosed herein may be applicable to other types of data containers or content streams. Storage access clients may be mobile clients, desktop clients, and/or web clients. Among other types of user content, users may store video content of various kinds on a NAS. It may be desirable for users, with the assistance of certain client applications, to have the ability to play videos stored on a NAS. That is, the NAS may advantageously provide video playback to client devices as an integral feature of the device. The terms “video content” and “content” are used here and according to their broad and/ordinary meanings, and may be used to describe a vide file or container, and/or video stream content contained within a file or container.

The heterogeneous nature of different client devices and preferences may require different media formats for playing video content. For example, certain formats for video and audio content may be necessary for a particular client, depending on certain memory and/or audio/visual resolution characteristics thereof; each different type of client may support a particular video and/or audio format or set of formats. In some situations, video files maintained by a data storage server may not be of a desired format for a particular device. Therefore, it may be desirable or necessary for the video file data transmitted to the client devices to be transcoded in some situations from a stored format into a format compatible with the decoding capability and/or other capability of the respective client device.

Certain challenges may be associated with situations in which a user client, while viewing a video file in a video content presentation interface, wishes to jump to another temporal point in the video file. The desire to jump to a substantially random temporal point in a video file may be indicated by the user through a user interaction in which the user tracks a cursor or play head of a video/media presentation interface, or the like, across a timeline segment of the interface, which operation/activity may be generally referred to as “seeking,” or “scrubbing.” Seeking using a video presentation interface seek element may provide a mechanism for the user to relatively quickly navigate a video file. However, seeking in connection with live-transcoded video streams can present certain issues. For example, in some implementations, in connection with a seeking request, a video player may request a byte of the video file in a random-access fashion. However, with respect to live-transcoded video streams, random-accessed bytes may not be yet transcoded concurrently with the request for the seeked-to byte. This may be due to the requirement in some live-transcoding implementations to generate transcoded bytes in sequence. In some implementations, a transcoder of the data storage server may be configured to continue to generate the sequential bytes until the desired byte is reached that was requested by the user/client, wherein the transcoder may then send such bytes to the client. However, such implementation may be impractical in some contexts due to the relatively long time that may be associated with reaching the desired byte requested by the client (e.g., browser application). Therefore, some data storage servers may not be configured to support live transcoding.

Some embodiments disclosed herein allow for live transcoding in addition to seeking functionality. For example, a transcoder of a data storage server (e.g., NAS) may be configured to implement live transcoding in connection with certain client functionality/application(s) associated with the respective server-connected client(s). While some transcoders may not generally allow for seeking in a live-transcoded stream, in some implementations, a transcoder and/or associated control circuitry may be configured to transcode a source video file in accordance with a timestamp parameter that indicates a time in the video file from where the transcoding is to begin.

In some implementations, the present disclosure provides solution for seeking in a live-transcoded video stream through the hiding of a progress/seek bar or element of a client video player program, wherein a customized progress/seek bar or element may be implemented in connection with the client interface. When the user seeks in a video file through interaction with the customized progress/seek bar or element, the timestamp associated with the seek input may be captured. In response to the seek input, the current video playback session may be stopped, and a further request may be sent for a new video stream starting at the timestamp-indicated point in the video file. Such requests, as provided from the client to the server (e.g., NAS), may not be byte-range requests, but rather start-time, or “timestamp,” requests.

In some embodiments, a network attached storage device and/or client device, may be configured to implement an application programming interface that allows for the requesting and provision of transcoded video content starting at an arbitrary start time/timestamp. In response to a seek interaction, a new stream may be passed to the video player of the client device as a new playback session. A custom progress/seek bar or element generated by the client may then be adjusted to reflect the new start time associated with the new playback session. From the user's point of view, the presentation of the video content may start from the new location in the video file, and the custom seek bar may reflect the change, wherein the seek may substantially appear to the user as a seamless presentation.

### Network-Attached Storage

Network-attached storage (NAS) drives/systems can provide file-level, or object-level, data storage over a computer network, wherein access to the stored data is accessible to one or more clients. Although certain embodiments are disclosed herein in the context of files, file servers, file systems, and other file-level references, it should be understood that such references, as used herein, may refer to object-level data, or any other type of data structure, depending on the implementation.

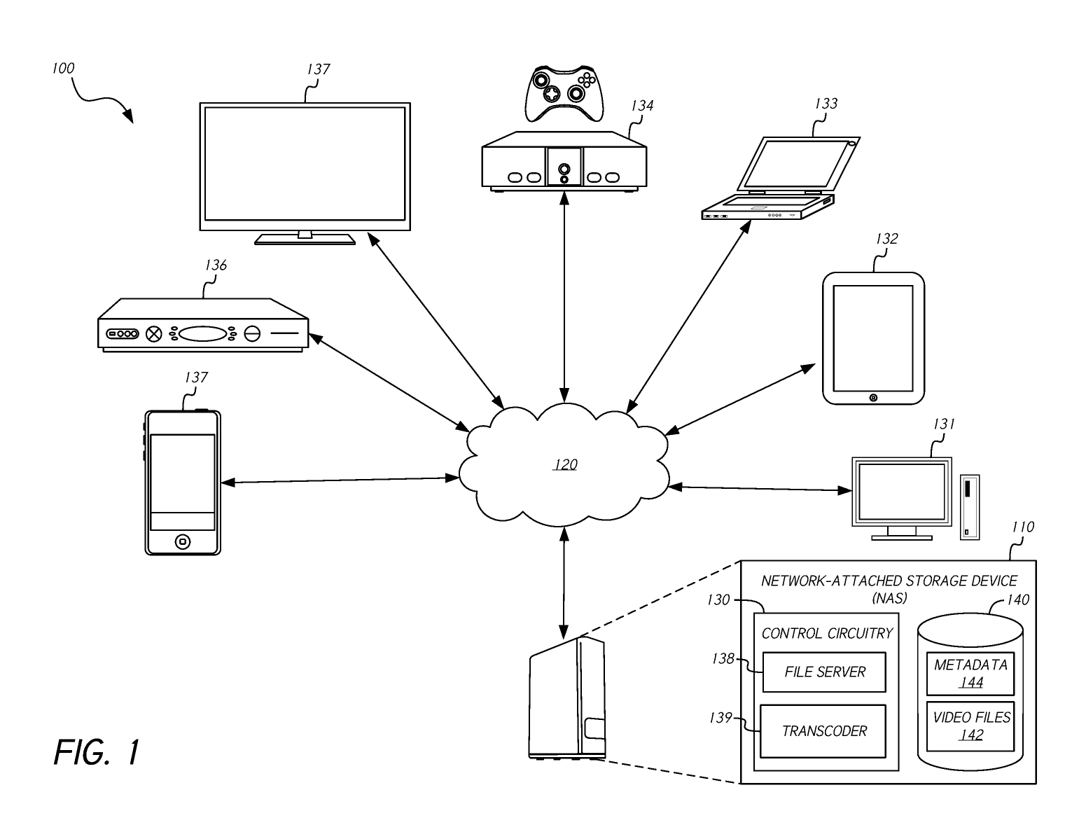

A NAS may include hardware, software, or a combination of such elements, configured such that the NAS operates as a file server. FIG. 1 is a diagram illustrating an embodiment of a NAS system 100, in which a network-attached storage device (NAS) 110 is communicatively coupled to one or more client devices over a network 120. The NAS 110 may provide file-based, or object-based, data storage services to devices coupled to the network 120. Types of client devices that may have access to the NAS 110 can include phones 137, such as smartphones, cable set-top boxes 136, smart TV's 135, video game consoles 134, laptop computers 133, tablet computers 132, desktop computers 131, wearable computers (not shown) and/or other network-connected computing devices. The network 120 may be a local area network (LAN), a wide area network (WAN) (e.g., the Internet), or other type of computer network, and the connections between the various client components of the system 100 and the network 120 may be either wired or wireless.

While certain embodiments are described herein in the context of NAS devices/systems, it should be understood that references herein to NAS's may refer to other types of data storage devices/systems, such as any type of computer device implementing software allowing for data storage access over a network or other connection. Furthermore, some embodiments disclosed herein may be implemented using data storage device connections that are not over a network, but rather a direct client/server connection.

In certain embodiments, the NAS 110 may be configurable over the network 120 by a client device interface, such as a web browser of a mobile or desktop computing device. An operating system (e.g., a relatively low-level operating system, such as FreeNAS) may be implemented in the NAS 110 by a control circuitry 130 thereof. The NAS 110 may provide access to files 142, such as video files, using one or more network file-sharing protocols, such as NFS, SMB/CIFS, AFP, or the like. The NAS 110 may comprise a data store 140 for storing the user data (e.g., video files) 142, as well as certain metadata 144, such as system tables or the like, and/or other types of data. The data store 140 may comprise one or more non-volatile memory devices or modules, and may include any type of data storage media (e.g., solid-state, magnetic).

The stored user data may include, for example, audio, video, still images, voice, text, or other form of media. Media content stored in the data store 140, such as video files 142, The stored media content may be embodied in containers, and may be in a single uncompressed container format for each media type. For example, audio files may be archived in data storage 14 as PCM (pulse code modulation) format, .wav or .aiff files, or as BWF (broadcasting wave format). Still images may be stored in FITS (Flexible Image Transport System) or TIFF (Tagged Image File Format). Video may be stored in AVI, ANIM, ASF, DVR-MS, IFF, MOV, MPEG-1, MPEG-2, MP4 or the like.

The NAS 110 may be configured to implement encryption for user data/files 142 stored in the data store 140. For example, the NAS 110 may implement Transport Layer Security (TLS), Secure Sockets Layer (SSL), and/or Advanced Encryption Standard (AES) keys (e.g., 256-bit, 128-bit, etc.) to protect files in rest and/or in motion. The NAS 110 may further be configured to implement one or more additional security features, such as user verification, forward secrecy, and/or the like.

The NASs 110 includes a file server 138 configured to serve video file content 142, such as transcoded video file content, to clients connected thereto and authorized to use such content. With respect to video playback of the video content 142 stored in the NASs 110, certain challenges may be associated with playback by a particular user of such content. For example, the video files 142 may comprise various video file containers and/or codecs. The term “codec” is used herein and according to its broad and/ordinary meaning, and may be used to describe a device or computer program for encoding or decoding a digital data stream or signal, such as a video stream, audio stream, or the like. The control circuitry 130 of the NAS 110 may implement one or more video and/or audio codecs to encode data streams for transmission to the various clients, possibly in encrypted form. The clients may comprise decoder functionality for reversing the encoding for playback or editing. For example, with respect to client devices implementing video playback of the video content 142 stored on the NAS 110, decoder codec functionality may be required to be implemented by the respective client device in order to interpret compressed or otherwise coded video content. Generally, not all client devices and/or systems support all codecs associated with various types of video files or containers. In addition to coding and decoding, it may be necessary in some implementations for the NAS 110 to modify video content resolution, which may allow for users/clients with relatively-lower bandwidth resources to have an improved viewing experience for video playback.

Modification of video content from one codec format to another, and/or the changing of resolution or bit rate of video content, may involve data transcoding. The term “transcoding” is used herein according to its broad and/ordinary meaning, and may refer to direct digital-to-digital conversion of one encoding to another, or any other type of data representation modification, such as resolution and/or bit rate modification, as described herein. “Transcoding” may be used herein to describe any modification of any property or properties of video or other content. Although certain embodiments are disclosed herein in the context of video files, should be understood that such embodiments and associated concepts and principles may be applicable with respect to audio files, and/or other types of data files are content.

In order to implement transcoding functionality, the NAS 110 comprises a transcoder module 139, which may comprise hardware and/or software components. The transcoder 139 may be configured to implement transcoding into any of a number of video formats, such as, for example, changing video properties from MP4 with H.264 video codec and Advanced Audio Coding (AAC) audio codec to MP4 with H.265 video codec and Audio Codec 3 (AC-3) audio codec, from Matroska Multimedia Container (MKV) with 1920×1080 (1080 p) pixel resolution to MKV with 1280×720 (720 p) pixel resolution, from MKV with 20 megabit per second (mbps) bit rate to MKV with 1 mbps bit rate, from video codec H.264 encoded video stream to video codec h264 encoded video stream, from video codec H.265 encoded video stream to video codec h.264 encoded video stream, and/or other transcodings. In some embodiments, the transcoder 139 comprises hardware for implementing hardware transcoding. For example, certain hardware logic may be utilized to perform the conversion of video content from one format to another, which may provide reduced burden on processor and/or other resources relative to a fully software-implemented transcoder. In certain embodiments, the transcoder 139 is configured to implement transcoder functionality using both hardware transcoding and software transcoding.

The video files 142 may be stored in any suitable or desirable file format. For example, with respect to movie files, video content may be stored in MKV format, or the like. With respect to videos captured on smart phones, for example, video content may be stored in QuickTime File Format (QTFF) (i.e., MOV), MP4, or the like. However, in some implementations, a client device may implement a media player that is not configured to play a format of a video file requested by the client from the NAS 110. For example, where a web browser media player application is implemented by the client, such browser application may be unable to play, for example, MKV format video, or the like. In some implementations, pre-transcoded video files 245 or content may be stored in the data store 140 of the NASs 110, such that the pre-formatted video compatible with the respective client application may be provided upon request for the associated video file. However, such implementations may undesirably require substantial write amplification, such that additional storage space is required to accommodate the additional copies of pre-transcoded content 245.

The transcoder 139 may be embodied in, or comprise, a transcoder application or tool residing at the NAS 110, such as an FFmpeg tool, or the like, which may provide certain libraries and programs for processing multimedia content, including audio/video codec libraries. Although certain embodiments are disclosed herein in the context of FFmpeg transcoder tools, it should be understood that the principles disclosed herein may be applicable in systems or devices utilizing any suitable or desirable transcoder tools or components. The transcoder 139 may be configured to generate various video and/or audio formats, such as streamable formats, wherein the transcoder 139 configured to live-transcode a video file to a desired format and/or modify resolutions thereof, and provide such transcoder/modified content to the requesting client.

Live Transcoding with Seeking Functionality

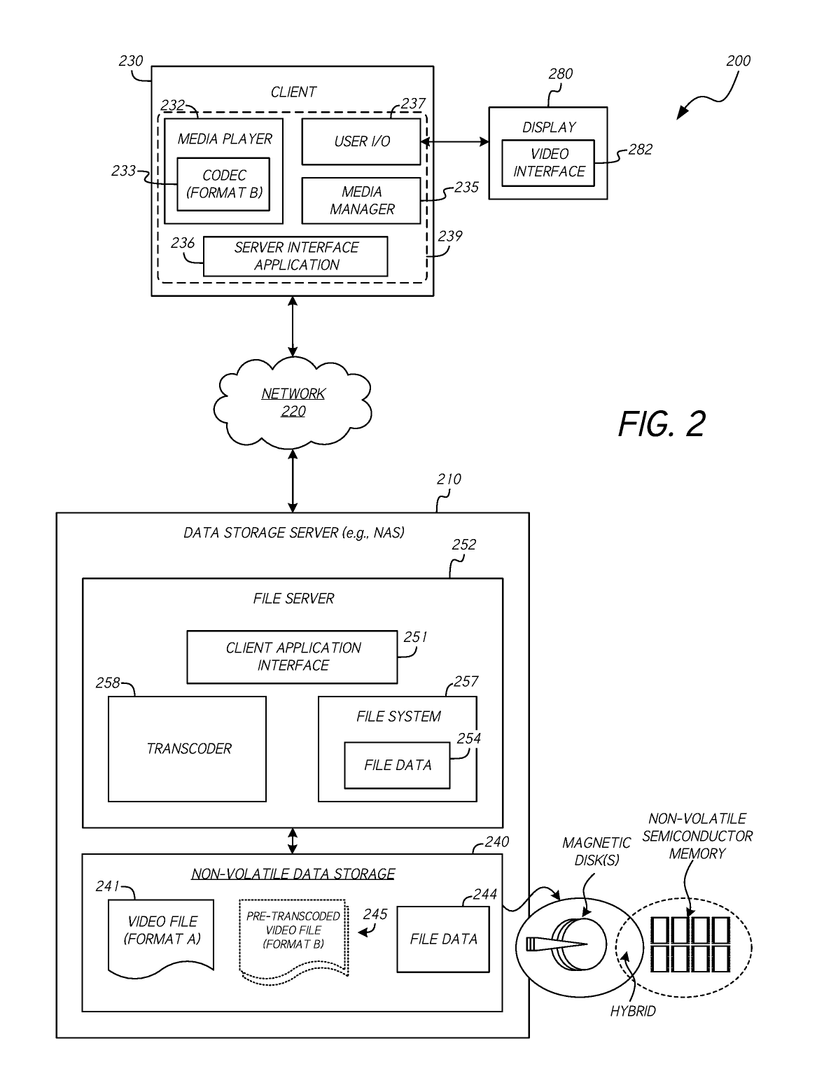

FIG. 2 is a block diagram illustrating a data storage server system 200, such as a network-attached storage (NAS) system, according to an example embodiment. The system 200 includes a data storage server 210, which may represent an embodiment of the NAS 110 of FIG. 1. Although the storage server 210 may represent any type of data storage server device or system, the storage server 210 may be described below in certain contexts as a NAS for illustration purposes. Referring to FIG. 2, the data storage server (e.g., NAS) 210 may include certain control circuitry or components configured to implement a file or object server 252. For example, the illustrated embodiment of FIG. 2 comprises control circuitry functional modules and components including the file server 252, client application interface 251, transcoder 258, and file system 257. The control circuitry of the various illustrated functional module may be implemented as a combination of one or more processors, chips/dies, field-programmable gate arrays (FPGA), data and/or power transmission channels or busses, volatile and/or non-volatile memory modules, stored code, and/or other components. Furthermore, although the control circuitry of the data storage server 210 is illustrated as various separate modules, it should be understood that the functionality represented thereby may be implemented using any configuration of modules or control circuitry.

The data storage server 210 includes non-volatile memory data storage 240. The data storage 240 may comprise one or more disks, wherein the NAS 210 further comprises one or more heads (not shown) actuated radially over the disk(s), and a spindle motor for rotating the disk(s). Alternatively, or in addition, to magnetic (or optical) rotating media, the non-volatile data storage 240 may comprise solid-state memory and/or other non-volatile memory. In certain embodiments, the data storage server 240 may comprise one or more hybrid hard drives including both magnetic media and solid-state media. In addition to the illustrated modules and components, the data storage server 210 may further include one or more additional network interfaces, processors, data and/or power communication buses, memories, boards, chips/dies, or the like.

The system includes a network connection 220 over which the client 230 may be communicatively connected to the data storage server 210. The network 220 may comprise any digital or other communications network capable of transmitting messages between senders and receivers. In various embodiments, the network 220 includes any number of public or private data connections, links or networks supporting any number of communications protocols. The network 220 may include the Internet, for example, or any other network based upon TCP/IP or other conventional protocols. In various embodiments, the network 220 also incorporates a wireless and/or wired telephone network, such as a cellular communications network for communicating with mobile phones, personal digital assistants, and/or the like. The network 220 may also incorporate any sort of wireless or wired local area networks, such as one or more IEEE 802.3 and/or IEEE 802.11 networks.

The data storage server 210 may comprise a NAS that may be, for example, a personal in-home box, which may be accessible by the client 230 either locally (e.g., over a LAN connection) or through a cloud-based connection. The client 230 may be configured to implement a server interface application 236 configured to communicate with the data storage server 210 according to a particular application programming interface (API). For embodiments in which the client 230 is a mobile computing device (e.g., smartphone), the server interface application 236 may be a mobile client application. The server interface application 236 may be configured to make video file access requests incorporating various parameters, including a timestamp parameter, as described herein. Where the client 230 is communicatively coupled to the data storage server 210 over a LAN connection, the client 230 may be configured to search for data storage server devices on the network 220, wherein such search may produce a list of all available devices based on, for example, IP address.

The data and/or requests communicated between the client 230 and the data storage server 210 over the network 220 may be implemented through a particular communication protocol that both the server interface application 236 of the client 230 and the client application interface 251 of the data storage server 210 are designed to execute. For example, in an embodiment, the client 230 and data storage server 210 communicate according to a representational state transfer (REST) application programming interface (API), or other stateless interface, which may provide desirable interoperability between the system components over the network 220. The implemented API may allow for clients to utilize the file system 257 of the data storage server 210 by requesting files as network resources identified by, for example, a network address (e.g., Uniform Resource Locator (URL), Uniform Resource Identifier (URI), or the like). The requests communicated by the client 230 to the data storage server 210 may comprise, for example, HTTP requests (e.g., HTTP 1.1, HTTP/2). The file server 252 may receive data and storage access commands using the client application interface 251, which may be configured to communicate with the client 230 according to the relevant API (e.g., REST API). In certain embodiments, the client 230 utilizes a DNS server in communicating with the data storage server 210; the data storage server 210 may be callable through a web address URL (Uniform Resource Locator).

The client 230 may comprise control circuitry 239 configured to implement the functionality of the illustrated modules/components thereof. In certain embodiments, the client 230 is configured to implement a virtual file system (not shown). In some embodiments, the connection between the client 230 and the data storage server 210 may be wired, such as through Ethernet, USB, or other connection, or may be wireless, such as through WiFi, Bluetooth, or other wireless connection. In certain embodiments, the connection between the client 230 and the data storage server 210 is achieved over the Internet, wherein each of the client 230 and the data storage server 210 is connected to the Internet over a wired or wireless connection.

The data storage server 210 may be configured to implement data redundancy, wherein copies or portions of user data stored in the data storage 240 are maintained in one or more internal and/or external drives. For example, the data storage server 210 may implement redundant array of independent disks (RAID) technology, wherein the non-volatile memory array 240 includes a plurality of internal drives, disks, or other data storage partitions combined into a logical unit for the purposes of data redundancy and performance improvement. In addition, or alternatively, the data storage server 210 may be configured to implement RAID using one or more internal memory modules in combination with one or more external memory devices. Furthermore, data may be distributed across the RAID memory modules/drives according to any desirable or practical RAID level, depending on the level of redundancy and/or performance desired. For example, the data storage server 210 may be configured to implement RAID 0, RAID 1, RAID 5, RAID 10, or other RAID technology, depending on data reliability, availability, performance and/or capacity considerations or requirements.

The data storage server 210 may implement a file system 257 that may be accessible by the client 230 through the server interface application 236 for browsing and/or searching. For example, the non-volatile data storage 240 may comprise some number of fixed-size data segments of data storage (e.g., blocks). The non-volatile data storage 240 may be configured to process relatively simple data access commands, wherein such commands are received from the file server 250 over a communication interface (e.g., Integrated Drive Electronics (IDE), Small Computer System Interface (SCSI), Serial ATA (SATA), or the like). The file system 257 may implement files, file directories, and/or other data structures that represent data stored in the non-volatile data storage 240. In certain embodiments, the file system 257 maintains certain metadata 254 (e.g., tables) for associating logical files with physical block numbers, or the like. For example, the file data 254 may comprise a file allocation table (FAT) that describes file/block associations. The file data 254 may further track unused blocks and/or allocate new blocks, as needed. In certain embodiments, the file server 252 is configured to provide a file list to the client 230 for representing to the client 230 the accessible files of the file system that are available to the client 230.

The control circuitry 239 of the client 230 may be configured to implement seeking functionality in connection with live-transcoding, as described herein. The control circuitry 239 may utilize a media manager module 235 to implement the seeking/live-transcoding functionality in accordance with one or more embodiments disclosed herein, and may be configured to direct certain media content retrieval, presentation, and/or encoding/decoding functionality of the client 230. The media manager module 235 may generally control the functionality of the media player 232 in some embodiments.

The client 230 may comprise a server, a desktop, a laptop, a tablet, a handheld device, or the like, and includes the control circuitry 239, which may comprise one or more central processing units (CPUs), memory/data storage devices or modules, network interfaces, and/or input/output interface components, and the like. The control circuitry of the client 230 may be configured to execute certain software applications for implementing the functionality described herein, such as the media manager 235 and/or media player 232. The media manager 235 and/or media player 232 may comprise applications that may be executable within an operating system (OS) implemented by the control circuitry 239 of the client 230. The client may one or more local storage devices (not shown), such as hard disks, flash memory modules, solid state disks, optical disks, and the like. In certain embodiments, the client 230 comprises a network interface (not shown) for connecting to the network 220, which may include one or more network adapters (e.g., network interface cards (NICs)).

As described herein, the file server 250 may provide access to resources therein through a representational state transfer (REST) application programming interface (API) implemented by the client application interface 251. Accordingly, the file server 250 may be configured to invoke operations in the data storage server supported by REST API. The client application interface 251 may be configured to implement various API operations (e.g., REST API operations) that can be invoked by the client 230 through communication with the data storage server 210. API operations can include, for example, creation of, and/or access to, video files maintained in the non-volatile data storage 240.

The client 230 may operate as a “client” and data storage server 210 may operate as a “server” in a REST architecture. As is known in the art, REST provides a software architecture for creating scalable web services. In a REST architecture, the functionality of the “client” can be separated from the functionality of the “server.” Communication between the client 230 and server 210 may be through the REST API. In general, the client/server techniques described herein can be used in any system having a similar REST architecture having one or more clients (client computing systems) communicating with one or more servers (server computing systems), each server implementing a REST API through which clients can invoke API operations. Each API operation can be any type of service, application, or the like that can be executed by the data storage server 210 on behalf of the client 230.

The media player 232 and/or media manager 235 may be configured to send requests, as translated by the server interface application 236 for communication according to the relevant API, via the network 220 to the data storage server 210. The responses from the data storage server 210 may be translated by the server interface application 236 according to the API, and passed to the media player 232 and/or media manager 235. Storage access commands communicated by the server interface application 236 may include video file access commands issued by the media player 232 and/or media manager 235. The video access commands may specify a video file address/location and a timestamp parameter.

The media player 232 may comprise a standard media player, and may be configured to request video data over the network 220 using a relevant network application protocol, such as hypertext transfer protocol (HTTP), or the like, by specifying a location (e.g., uniform resource locator (URL)) of the video file. In some implementations, the media player 232 may be a web-browser media player, which may be configured to use a video element (e.g., HyperText Markup Language (HTML), HTML 5) associated with the browser to process and/or present video content. In some implementations, the media player 232 may be a mobile application for a mobile device client, such a smart phone. The media player 232 may be designed to accept a resource location (e.g., URL) that points to a video file stored at the data storage server 210, and to play such file. The media player 232 may generally operate under the intrinsic assumption that a requested file requested from the data storage server 210 is available in its entirety when the file location is passed to the media player 232, such as by the media manager 235. However, where the video file needs to be live transcoded, such assumption may not be in accordance with reality.

The media player 232 may comprise one or more codecs 233, which may be configured to decode (and/or encode) video content, such as for presentation using a video interface 282 on a display 280 associated with the client 230. The codec 233 may be designed to decode data compressed in a particular format (e.g., format B). Format B represents a generic video format, and may be any suitable or practical video format, such as H.264, H.265, MPEG-4, or the like. In certain embodiments, the media player 232 comprises audio codec components and/or functionality. Only certain video formats may be streamable by the video player 232.

The client 230 and/or other client/user may maintain video content on the non-volatile data storage 240, among possibly other types of data (e.g., audio, text, etc.). One characteristic of video files that may be relevant in certain environments is the relatively large size of some video files relative to other types of files. In view of such size, may be difficult or undesirable to upload the entire video file to the client 230 prior to initiating playback thereof. Therefore, streaming of video content may be desirable in order to improve the playback experience of the client 230. The video file 241 may be stored in the non-volatile data storage 240 in any suitable or desirable manner. For example, a user/client may provide the file for storage over a wired (e.g., USB) local connection, or over a remote or local wireless connection.

The video file 241 may comprise a video file container that includes a compressed video stream in addition to one or more additional components of the container/file. For example, in certain embodiments, the video file continued 241 includes one or more video streams, audio streams, subtitle streams, and/or other types of data. Depending on the type of container, the video file 241 may represent the video stream in any of a variety of possible formats. In certain embodiments, the video file container comprises multiple streams of information, as well as a header field, which may provide certain metadata associated with the video file 241. For example, the video file 241 may comprise a single video stream, an advanced audio coding (AAC) audio stream and/or a dedicated-to-sound (DTS) audio stream, as well as subtitle streams in one or more languages. The video file 241 may comprise any suitable or desirable format, such as MP4, MKV, Audio Video Interleaved (AVI), or the like. In addition to the video codec and/or audio codec, the video file 241 may have certain other properties, including resolution, frame rate, bit rate (e.g., bits per second (bps)). The video stream codec may be any suitable or desirable codec, such as H.264, or the like. The audio codec may be any suitable or desirable codec, such as MP3, AAC, AC-3, or the like. With respect to the resolution parameter, which may define the width and/or height of the video stream images, examples may include 1080 p, or other resolution. With respect to frame rate, examples may include 60 frames per second (fps), 30 fps, or other frame rate. With respect bit rate, examples may include 20 Mbps, 1 Mbps, 2 Kbps, or other bit rate.

In certain embodiments, the non-volatile data storage 240 may comprise pre-transcoded video file data 245. For example, the data storage server 210 may be configured to generate and/or store pre-transcoded video file data in the non-volatile data storage 240 in order to provide transcoded video file content to the client 230 without the need for live transcoding. For example, when a user/client adds a video file to the non-volatile data storage 240, the file server 252 may transcode the video file automatically into various resolutions and/or formats so that users/clients can request the resolution and format desired. However, pre-transcoding may require substantial amounts of storage space to accommodate the pre-transcoding video file data 245, and may therefore be undesirable in certain solutions.

Encoding of video data may be desirable and/or necessary in order to reduce the amount of resources required to store and/or transmit a video file. With respect to a video file, the video content may comprise interlaced video frames, wherein each frame comprises an image. Therefore, as a video file comprises a plurality of images, depending on the frame rate of the video, storage of the individual images that make up the video file content may result in the requirement of a substantial amount of storage space to store the video file. Therefore, it may be desirable for the video content be encoded to compress the video content in accordance with one or more encoding/compression techniques. The codec 233 may be configured to decode encoded/compressed data to produce viewable video content, wherein the video stream produced by said decoding may be provided by the media player 232 to a display interface to 282 via user input/output (I/O) circuitry or component(s) 237.

The user I/O module 237 may provide an interface for communicating with a user using one or more I/O components, such as the display 280 and/or one or more user input device interfaces (e.g., mouse, keyboard, touchscreen, or the like). The user I/O module 237 may provide the video interface 282 for viewing, by the user, certain video content and/or progress/seek element(s), and for interacting therewith. The user may interact with the video interface and/or other I/O component(s), such as through the act of moving a slider icon or feature of the video interface 282 in association with a video playback to indicate a desire to play the relevant video at a different point or time in the video. Such seeking input may be common when users are playing relatively long videos and desire to skip a portion of the video.

The media player 232 may provide seeking/scrubbing functionality through implementation of a seek element or mechanism (e.g., seek bar). Although seeking functionality as described herein in the context of seek bar features or elements, should be understood that seeking interfaces and functionality may be implemented in connection with any suitable or desirable type of seek element having any visual or functional configuration. In certain embodiments, seeking may be implemented with respect to the media player 232, such that when a user interacts with the video interface 282 to provide seeking input via the user I/O 237, the media player 232 may determine where in the relevant video file the data for the target point in the video indicated by the seeking input may be available. For example, the media player 232 may determine the location of the target point in the video file by relying on the information in the header of the video file and/or through the use of certain heuristics. Once the media player 232 determines which byte or segment in the video file is desired, it may provide a request to the server 210 to provide the video file starting with the particular byte determined by the player to be associated with the user's seeking input. Such request to the server 210 may be considered a “byte-range request,” which may be generally associated with HTTP command protocols.

In some implementations, seeking functionality is implemented according to the following process: a user may start video playback through interaction with the user I/O component 237, which may result in the media manager 235 constructing a byte-range request to the file server 252 indicating start byte ‘0’ (i.e., the start of the video file), wherein the media player 232 may thereby receive the video file from the file server 252 and provide video content to the user via the video interface 282. When the user interacts with the video interface 282 to seeking to a random point in the video file (i.e., provide “seek input,” or “seeking input”), such information may be processed by the media player 232, wherein the media player 232 is configured to compute a byte, or byte range, associated with the seeked-to point in the video file and provide a request to the file server 252 to retrieve the video file at the byte(s) associated with the seek input, and provide the video content received in response thereto to the user via the video interface 282.

Complications in implementing seeking functionality may arise because when the media player 232 plays a video file (e.g., video file 241), the media manager 235 may provide to the media player 232 a location of the video file, wherein the media player 232 requests the video file and plays it. Furthermore, in order to implement seeking functionality, it may be necessary to retrieve the appropriate file content, and to estimate where the seeked-to point in the video file is located, and request such segment of the video file, and provide video streaming from that segment of the video file. However, for live streaming, transcoded video content may be streamed by the server 210 on a byte-by-byte or segment-by-segment basis, such that the media manager 235 may be unable to determine the location of a not-yet-transcoded byte of the video file, as desired according to the seeking input. That is, for live-streaming applications, it may not be possible or practical to randomly seek within the video stream without transcoding the video file up to the desired point of the file, which may prove undesirably inefficient in some contexts.

In some embodiments, the media manager 235 may be configured to implement the video interface 282 by hiding the default progress/seek bar or element in order to present a substitute seek bar for interaction therewith by the user. For example, the media player 232 may be designed to implement the video interface 282 in a first state, wherein seek controls are implemented in the interface by the media player 232, or alternatively to run the interface 282 in a second state, wherein the native seek bar controls are not shown. Rather, the media manager 235 may be configured to draw custom controls (e.g., custom seek bar) for implementing seeking in connection with the interface 282. The custom seeking controls may be implemented as a separate interface from the media presentation interface 282, or may be integrated in some manner with the video interface 282. For example, the media manager 235 may be configured to effectively draw a separate seek bar in the video interface 282, and handle events associated with interaction therewith. The custom seek bar implemented by the media manager 235 may be visually integrated with the video interface 282 provided by the media player 232

When the user interacts with such substitute seek bar, the media managed 235 may be configured to end the existing video playback session of the media player 232 and start a new video playback session. For example, as directed by the media manager 235, the media player 232 may request that the file server 250 close the current playback session, and further request a new playback session starting at a specified time in the video file. At the file server 252, the transcoder 258 may then be provided content of the video file 241 associated with the specified time and perform transcoding and streaming of the video content from that point.

The transcoder 258 of the data storage server 210 may be configured to implement conversion of video and/or audio content from one format/codec, resolution, or bit rate, to another. The transcoder 250 may comprise hardware for hardware transcoding, which may free-up processor and/or other resources relative to exclusively-software-implemented transcoding embodiments. In certain embodiments, the transcoder 258 may comprise hardware that is a component of a system on a chip (SOC) of the data storage server 210, wherein the SOC comprises some or all of the control circuitry of the file server 252. In certain embodiments, the transcoder 258 comprises software code/firmware for implementing transcoder functionality and/or interacting with hardware transcoder component(s).

In some implementations, the media player 232 and/or codec 233 may not be configured to decode the video content of the video file 241 in the stored format (e.g., format A). Therefore, the transcoder 258 may be designed to convert the video content of the video file 241 from a first format that is incompatible with the media player 232 to a second format (e.g., format B) that is compatible with the media player 232 and codec 233. The file server 252 may be configured to feed the video file content 241 to the transcoder 258, wherein the transcoder provides output comprising transcoded video content (e.g., as a stream of bytes or the like), and provides such output to the media player 232 over the network 220. In some implementations, the transcoder 258 serves to direct the to-be-decoded file to the appropriate hardware transcoder block(s). The hardware component of the transcoder 258 may perform certain video transcoding. In certain embodiments, the transcoder video content may be assembled with associated audio stream(s), and/or may be converted to an appropriate bit rate or resolution. A software component of the transcoder 258 may implement such functionality, while performing part of transcoding process using hardware component(s).

With respect to live transcoding, the client 230 may provide a request including one or more of a file name or other identifier, desired video content resolution, and/or desired bit rate, over the network 222 the file server 252. The file server 252 may provide the requested input file to the transcoder 258, which may produce an output stream and provide the same to the client application interface 251, which forwards the responsive video stream to the client 230 in accordance with the relevant API. In certain embodiments, the transcoder 258 provides the transcoded video stream output dynamically as the bytes of the video stream are generated by the transcoder. Therefore, if a user provides seeking input while playing the live-transcoded video stream, in response to which the media player 232 requests a byte of the video in a random-access fashion, the requested byte may not have been transcoded by the transcoder 258 at that point in time. For example, the transcoder 258 may be generally configured to generate transcoded bytes of the video stream in a sequential manner, such that non-sequential subsequent bytes in the video file will not have been transcoded at a given point in time. In certain embodiments, the transcoder 258 may continue to generate transcoded bytes until the desired byte requested by the media player 232 is reached, at which point the desired transcoded byte(s) may be provided by the transcoder to the media player 232. However, such implementation may be impractical in certain contexts due to the relatively long time duration that may be associated with such operation in order to reach the requested byte(s).

As described above, where pre-transcoding is not implemented by the data storage server 210, video file data may need to be transcoded into the desired format for a particular client when the client requests data (i.e., live transcoding). For live transcoding, the video file may be fed to the transcoder program (e.g., FFmpeg or the like) and/or hardware, which may generate the transcoded video as a series of bytes. The transcoded bytes may be sent back to the client 230 as the bytes are generated.

In some implementations, the present disclosure provides systems and methods for providing live transcoding without pre-transcoding. Such solutions may allow for seeking in a live-transcoded stream by directing a transcoder to transcoder the video file at a specified start time, wherein the client application interface 251 and/or server interface application 236 are configured to communicate video file access requests and service thereof, wherein the requests include a start time (e.g., timestamp) parameter, as opposed to byte-range requests.

In some implementations, the system 200 is configured to implement seeking in a live-transcoding video stream by hiding a progress and seek bar associated with the media player 232 and implementing a custom progress/seek bar, with which the user may interact. When the user seeks using the custom progress/seek bar, the media manager 235 may capture the timestamp associated with the seek input, and may stop the current video playback and request from the file server 252 a new video stream starting at the specified timestamp. That is, rather than requesting a byte-range request, the media manager 235 may direct a start-time request. The server interface application 236 and client application interface 251 may be configured to implement an application programming interface (API) to provide transcoded video starting at an arbitrary start time. The new stream may be passed to the media player 232 as a new playback session. Furthermore, the custom progress/seek bar may be adjusted to reflect the new time specified by the start time timestamp. From the perspective of the user, who may visually interact with the video playback on the display 280 and video interface 282, the video may appear to start from the new start time location, and the seek bar associated with the video interface 282 may reflect the new position. Visually, the presentation to the user may be relatively seamless.

In one use case, a user starts playing a video, such as by inputting an indication to start the video in some manner. The media manager 235, in response thereto, may direct the media player to play the requested video at a start time associated with the start of the video file (e.g., start time ‘0’). The media player may send an HTTP request or other request to the file server 252, wherein the request includes the location (e.g., address), a start time (e.g., start time ‘0’), and/or one or more other parameters, such as a filename or other identifying information. The transcoder 258 may forward a transcoded video stream to the client interface application 251 and on to the video player 232 of the client 230.

While the user is viewing the video stream on the display 280, the client 230 may receive seeking input from the user, such as via the user I/O 237. For example, such input may be received by the media manager 235, which may, in response thereto, direct the media player 232 to play the video file at a start time associated with the seeking input. The media player 232 may send a request for transcoded video content starting at the start time associated with the seeking input, such as an HTTP request or other protocol.

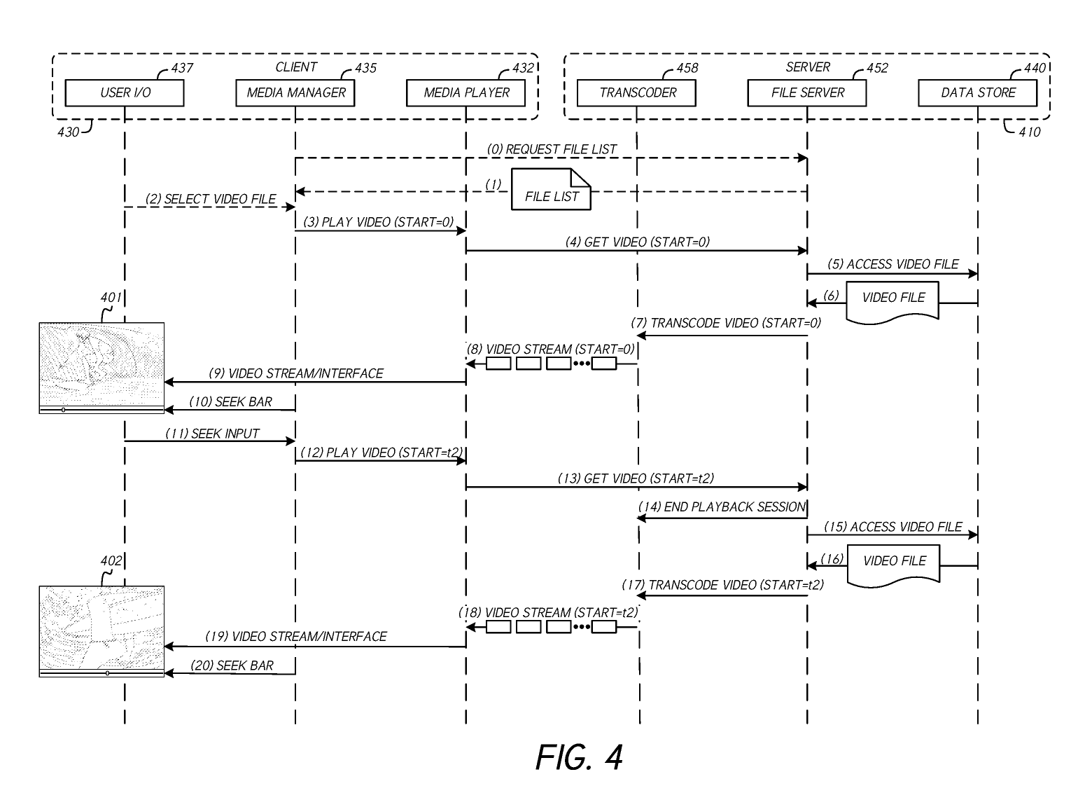

The file server 252, in response to the request, may end the running transcoder session, and direct the transcoder 258 to transcode the video file starting from the specified start time, as requested. The transcoder 258 may forward the new transcoded video stream to the client application interface 251 and on to the client 230. The process described above is described in greater detail below in connection with FIG. 4. Live-transcoding processes described herein may provide desirable video transcoding performance, and may at least partially obviate the need for pre-transcoding video content in certain implementations.

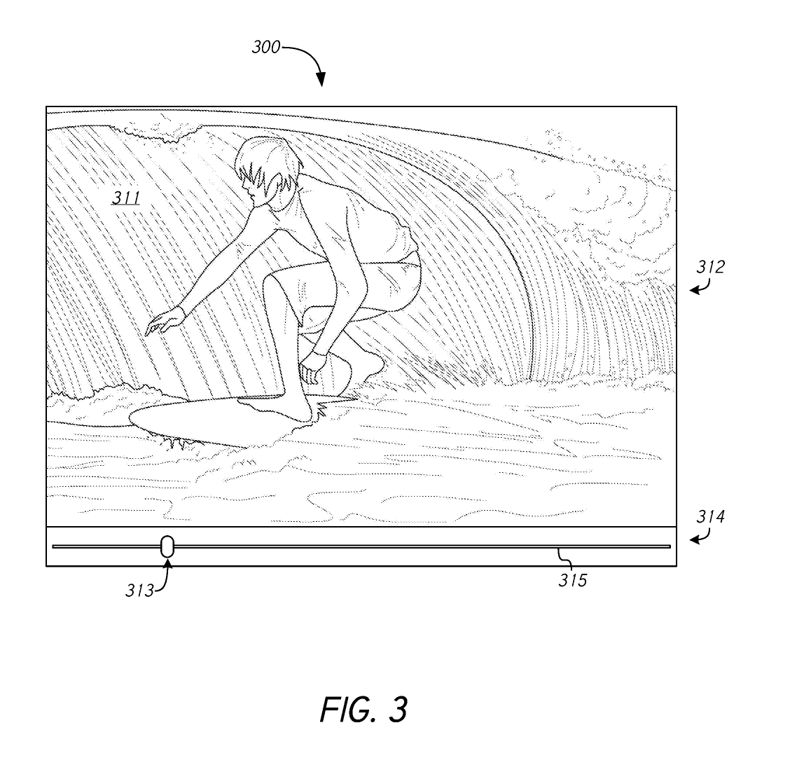

FIG. 3 illustrates an example video interface 300 in accordance with one or more embodiments of the present disclosure. The user interface 300 may allow for a user, through interaction therewith, to provide seeking input for jumping to a specified point in time of a video file. The specific point in time seeked to by the user may be an arbitrary or random point in time with respect to the video timeline 315 from the perspective of the associated transcoding system in some implementations.

The interface 300 comprises a timeline feature 315, wherein a geometry of the timeline corresponds to an extent of at least a portion of the video content being viewed. Although the timeline 315 is illustrated as a line segment having endpoints corresponding to the beginning and end of a least a portion of the viewed media content, it should be understood that the timeline 315 may comprise any suitable or desirable geometry or configuration. The seek bar 314 comprises an icon 313 that may be utilized to visualize a current location within the video that is currently being viewed, wherein the icon 313 may be displayed at a point along the timeline 315 at a location that proportionally corresponds to the position of the viewed media 311 within the extent of the video file. The window 312 the interface 300 may provide a window in which the video content images may be displayed for viewing.

In some implementations, by moving the icon 313 back and forth along the timeline 315, the user may be enabled to select a particular point in time in the video for viewing. In the illustrated embodiment, the seek bar 314 provides a linear scrubber element. In some embodiments, the movement of the slider, or thumb, icon 313 may trigger the provision of seeking input to the associated media player/manager and/or other system module(s)/component(s). In some embodiments, the user may enter a confirmation gesture in connection with movement of the icon 313 in order to trigger the seeking input. For example, where a user touches or clicks on the icon 313 to engage the icon for movement thereof, release of the touch or click may trigger the provision of the seeking input to the media player/manager.

In some embodiments, the interface 300 may be implemented such that a native or default seek bar associated with the interface and/or associated media player may be removed or hidden. For example, the media player interface 300 may be initiated in a state wherein native or default controls are omitted or hidden. Rather, the seek bar 314 may be implemented as a custom seek bar by a media manager module of the client, rather than as a native feature of the relevant media player. When the user executes seeking input through interaction with the slider icon 313, the media player/manager may be configured to end or destroyed the existing player, and start a new player by requesting that a current transcoder program connection be closed and providing a new request specifying the timestamp associated with the seeking input from the user. The file server may then locate the specified timestamp in the video file and start the trans-coded stream from that point.

FIG. 4 illustrates a sequence diagram for implementing live transcoding with seeking functionality in accordance with one or more embodiments of the present disclosure. The process illustrated in FIG. 4 may allow for seeking within a live-transcoded video stream through the use of timestamp-based video content requests that specify a point in time in the video file that is desired to be viewed by the media player. Such timestamp parameter data may be derived from user input received through interaction with a custom seek bar implemented by control circuitry of a client in order to capture time data associated with a seek request. It should be understood that although certain operations and events are identified by numbered references, such letter references do not necessarily imply temporal order of such operations/events, and such operations/events may occur in any suitable or practical temporal order. Furthermore, various operations or events may be included in the process of FIG. 4 that are not illustrated therein, and certain operations or events shown in FIG. 4 may be omitted in certain embodiments.

Operation (0) identified in the diagram FIG. 4 may involve requesting, by a media manager 435, a file list or other representation of files stored in the file server 452. For example, the client 430 may implement media manager software, such as a web application or the like, that may be configured or designed to, when executed, cause the client 432 request from the server 410 a list of all files available, or other list of file data available to the user. In some embodiments, the operation (0) may be initiated by a user opening a client application and/or indicating to the client application to retrieve the file list of file data on the server 410.

In response to the request for the file list, the file server 452 may provide, as illustrated as operation (1), a file list or other information indicating available files stored at the file server and/or accessible by the client 430. The file server 452 may retrieve the file list, and display file list in a web browser interface, for example. That is, the file server 452 may provide web page data (e.g., HTML), or other data that may be viewed by the client, identifying the available files. The media manager 435 may present the file list to the user and allow the user to select a file through interaction with the interface in which the file list data is presented to the user. In certain embodiments, the file list may provide unique identifier information or file, such as filename or the like.

As shown as operation (2), the user may select a video file through interaction with an interface or other mechanism presented to the user via user I/O circuitry and/or components 437. Based on the unique identifier and/or other metadata associated with the selected video file, the media manager 435 may be configured to construct or determine the location for the file at the server 410. The media manager 435, as shown as operation (3), may then provide the location of the selected file to the media player 432. For example, when the user selects a file, the location of the selected file content may be derived using the file list data. In certain embodiments, one or more access tokens may be required in order to access the selected file. Therefore, the request to the media player 423 (operation (3)) and/or the substantive request by the media player 432 to the file server 452 (operation (4)) may include access token data authorizing access by the client 430 to the selected file. The instruction provided as operation (3) in FIG. 4 may instruct the media player 432 to play the selected file at a start time associated with the beginning of the video file. That is, the request (operation (3)) may specify a time rather than a byte starting point for the video file. The media manager may construct the file location (e.g. URL) and choose the start time to be for example, ‘0’ (e.g., 0 seconds, or 0 s), and provide the location to the media player 432 and instruct media player 432 to play the file at the specified location at a start time ‘0’.

In operation (4), the media player 432 sends a request to the file server 452 to retrieve the selected video file at the specified start point, such as at a start point associated with the start of the video file (e.g., start time ‘0’). The request may be, for example, an HTTP request (e.g., ‘GET’ request), or request conforming to any other suitable or desirable protocol. The media player 432 may be configured to accept a file location, as provided by the manager 435, and contact the file server 452 to begin a playback session. The media player 432 may implement a video element, such as an HTML 5 video element for a web browser application, or other type of video element.

In some embodiments, the request associated with operation (4) may be a byte-range request indicating a starting byte or byte range of the video file. In some embodiments, the request at operation (4) is advantageously a timestamp-based request in accordance with embodiments disclosed herein. For example, the process of FIG. 4 may not involve byte-range requests, which may not be compatible with support for live transcoding, as described in detail above. However, the request may indicate a byte ‘0’ of the file, which may be associated with a start of the video file, or may alternatively or additionally include a start time (e.g., timestamp) parameter including a start time associated with the beginning of the video file. By sending the request at operation (4) to the file server 452, the media player 432 may thereby establish a playback session between the file server 452 and the media player 432.

At operation (5), the process may involve accessing, by the file server 452, video file content stored at a data store 440 associated with the server forecast. At operation (6), the process involves provision by the data store 440 of the accessed video file data, which the file server 452 may store in volatile memory. In some embodiments, the video file data provided by the data store 440 may be a portion of the complete video file/container stored at the data store.

At operation (7), the process involves the file server 452 initiating transcoding of the video starting at the start of the video file, as specified by the request of operation (4). For example, the file server 452 may initiate a transcoder process at the transcoder 458 and may provide bytes of the video file to the transcoder 458 as a stream of bytes. The file server 452 may provide the input file, as well as certain output parameters for the transcoder, as part of operation (7). For example, such parameters may include information indicating what format (e.g., MP4) the transcoded video file is to be converted to, what encoding format (e.g., H.264), as well as the start time for the transcoder to begin the transcoding of the video file.

At operation (8), the transcoder may provide transcoded video stream data to the media player 432. In certain embodiments, the transcoded video data may not be stored outside of the transcoder 458, but rather may be forwarded onto the media player 432 without storing. The transcoder 458 may access the video file and produce the output transcoded bytes and send the bytes back to the media player 432 without saving the output of the transcoder, such that there is no record of the transcoded file maintained at the server 410. In connection with the operation (8), the transcoder 458 may provide the video stream starting at start time ‘0’.

The media player 432 may then, at operation (9), provide the received video stream for presentation to a user via the user I/O component(s) 437, which may include, for example, a display screen or the like. In some embodiments, the media manager 435 may be configured to implement the media player 432 interface without controls, thereby hiding the seeking controls of the media player interface. Rather, at operation (10), the media manager 435 may provide a custom seek bar for the interface 401. For example, the custom seek bar may be drawn by the media manager 435 using any suitable or desirable formatting. The custom seek bar/element may be drawn in the video play window or other area of the interface provided by the media player 432.

At operation (11), the process involves receiving seek input from the user via the user I/O 437. For example, the user may interact with the interface 401, and seek element associated therewith, to provide seeking input to the media manager 435 via the user I/O 437. The seek input may be provided using the custom seek bar, wherein the custom seek bar element is configured to capture the seek request input and provide to the media manager 435.

At operation (12), the media manager 435 instructs the media player 432 to play the video file starting at a time associated with the seek input, as determined by the media manager 435. For example, the instruction to the media player 432 may include the same location information as provided in connection with operation (3), but the request may be accompanied by a different timestamp based on where the user has seeked to in the video file, as determined by the interaction with the custom seek bar. The instruction to the media player at operation (12) may generally instruct the media player 432 to end the current playback session. That is, the requests at operation (12) may represent a new file playback request.

At operation (13), the process involves sending a new video access request by the media player 432 to the file server 452 to access the video file starting at a timestamp (e.g., start time t2, wherein t2 represents the time seeked to by the user). That is, the media player 432 may make a new request and play the file as if it is playing a new file, though the file being played is the same as the file requested in connection with operation (4) described above. From the perspective of the media player 432, the file being played may be viewed as a different or new file with a new location, and the media player 432 may initiate a new playback session with the file server 452 through communication of the request at operation (13).

The process of FIG. 4 may be distinguishable from certain other implementations in which the media player may play a file and, in response to seek input from user, handle the seeking in the file within the same playback session, wherein the media player determines the byte(s) associated with the seeking input and provides a byte-range request based thereon as part of a single playback session between the media player and the file server

At operation (14), the process involves the file server 452 ending the current transcoding operation being implemented by the transcoder 458. In some implementations, at operation (15), the process may involve re-accessing, by the file server 452, the video file content stored at a data store 440 associated with the server request, and providing the video content, or portion thereof, from the data store 440 back to the file server 452.

In operation (17), the file server 452 may provide video content transcoder 458 transcoding the video file starting at the specified timestamp (e.g., start equals T2), rather than starting at start time ‘0’, as at operation seven. The transcoder 458 may be configured to implement a mechanism wherein the input video file may be skipped through to a specified start time, in this case the specified timestamp T2, and begin producing transcoder bytes from that point in time in the video file. Alternatively, the file server 452 may recognize the presence of the file content as already present in the memory of the file server, as previously downloaded at operation (6).

At operation (18), the process involves providing the transcoded video stream from the transcoder 458 to the media player 432. At operation (19), the process involves providing the received transcoded video stream and associated interface for presenting the video stream to the user via the user I/O 437. Once again, the interface provided by the media player may be implemented without controls, wherein the media manager 435, at operation (20), may provide a custom seek bar for viewing in connection with, or integrated with, the interface 402.

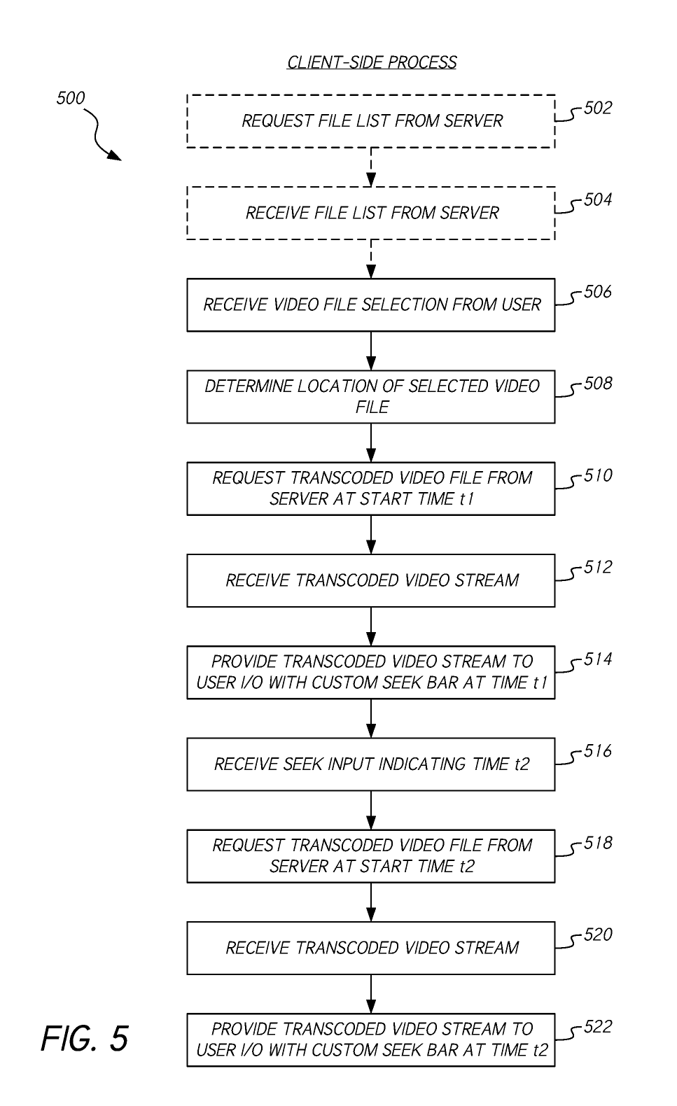

FIG. 5 is a flow diagram illustrating a process 500 for implementing seeking functionality in a live-transcoding environment in accordance with one or more embodiments. One or more of the operations or steps of the process 500 may be implemented at least in part by one or more components of a client device or system, as described herein, such as by a media management module and/or media player module thereof. Furthermore, the process 500 may include one or more additional steps not shown in the diagram of FIG. 5, and/or may omit certain step(s) shown in the diagram of FIG. 5.

At block 502, the process 500 involves requesting a file list or other file identifier information from a data storage server. At block 504, the process 500 involves receiving the file list data from the server in response to the request associated with block 502. At block 506, the process 500 involves receiving a video file selection from a user, such as may be provided by user I/O components associated with the client system. The user video file selection indicates a video file that is desired to be accessed for playback and viewing by the user.

At block 508, the process 500 involves determining a location at the server of the selected video file based on, or in response to, the video file selection. For example, the location data may be derived at least in part from the file list data received from the server at block 504. At block 510, the process 500 involves requesting transcoded video file data for the selected video file from the server, wherein the request specifies a start time for the requested video file content. For example, the start time corresponding to the operation of block 510 may correspond to a start of the video file, such as at a time t1=0 s.

At block 512, the process 500 involves receiving back from the server a transcoded video stream, which may comprise a stream of bytes of the video file starting at the requested start time t1. At block 514, the process 500 involves providing the transcoded video stream to the user I/O components along with a video presentation interface and a custom seek bar associated therewith, wherein the custom seek bar may reflect the start time t1. For example, a slider icon of the custom seek bar may be positioned at a position along a timeline of the seek bar indicating the start of the video file initially.

At block 516, the process 500 involves receiving seek input from the user I/O that indicates a desired time for viewing by the user. For example, the user may interact with the slider icon or other feature(s) or element(s) of the custom seek bar to indicate a desire to access or view a point in the video file associated with a particular time t2. At block 518, the process 500 involves requesting transcoded video file content from the server at the time associated with the seek input (i.e., t2), as determined at block 516. At block 520, the process 500 involves receiving the transcoded video stream, which may include transcoded video content starting at the requested time t2. At block 522, the process 500 involves providing the transcoded video stream to the user I/O with a custom seek bar, wherein the custom seek bar indicates the current time of the video playback t2.

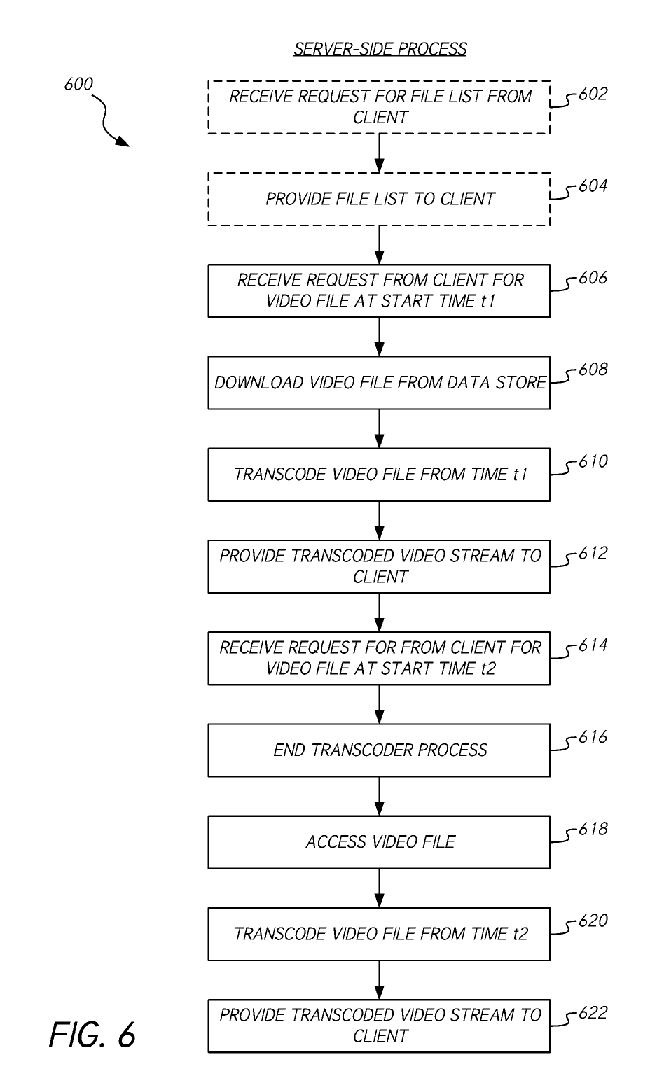

FIG. 6 is a flow diagram illustrating a process 600 for implementing seeking functionality in a live transcoding environment in accordance with one or more embodiments. One or more of the operations or steps of the process 600 may be implemented at least in part by one or more components of a data storage server, such as by a file server module or components and/or transcoder module or component. Furthermore, the process 600 may include one or more additional steps not shown in the diagram of FIG. 6, and/or may omit certain step(s) shown in the diagram of FIG. 6.

At block 602, the process 600 involves receiving a request for a file list from a client device or system. At block 604, the process 600 involves providing file list data to the client in response to the request received a block 602. At block 606, the process 600 involves receiving a request from the client for a video file at a start time t1. That is, the request from the client may specify a timestamp parameter indicating a point at which the video stream is desired to begin from. At block 608, the process 600 involves downloading the requested video file, or at least a portion thereof, from a data store associated with the server.

At block 610, the process 600 involves transcoding the downloaded video file starting from the time t1, as requested. For example, a transcoder program may be configured to receive as a parameter a timestamp parameter indicating a starting point for the transcoded output stream provided by the transcoder program and/or associated hardware. At block 612, the process 600 involves providing the transcoded video stream to the client starting at the desired timestamp point in the video t1.

At block 614, the process 600 involves receiving a request from the client for a video file at a second start time t2. That is, in certain embodiments, the request received from the client may be for the same file accessed and provided previously in the process, but may be part of a new file request from the client, wherein the timestamp data parameter associated with the request at block 614 may indicate or identify a separate point in the video file that is desired to be accessed. At block 616, in response to the request received a block 614, the process 600 may involve ending the current transcoder process initiated at block 610. The process 600 may further involve accessing, or re-accessing, the video file requested. For example, the video file may be accessed from the non-volatile data store, or may be accessed as a cash hit in memory of the server. At block 620 the process 600 involves transcoding the accessed video file from the second requested time point t2. The process 600 further involves providing the transcoded video stream to the client, wherein the transcoded video stream may begin at requested time t2.

### Additional Embodiments

Those skilled in the art will appreciate that in some embodiments, other types of video file seeking and/or live transcoding systems can be implemented while remaining within the scope of the present disclosure. In addition, the actual steps taken in the processes discussed herein may differ from those described or shown in the Figures. Depending on the embodiment, certain of the steps described above may be removed, others may be added.

While certain embodiments have been described, these embodiments have been presented by way of example only, and are not intended to limit the scope of protection. Indeed, the novel methods and systems described herein may be embodied in a variety of other forms. Furthermore, various omissions, substitutions and changes in the form of the methods and systems described herein may be made. The accompanying claims and their equivalents are intended to cover such forms or modifications as would fall within the scope and spirit of the protection. For example, the various components illustrated in the Figures may be implemented as software and/or firmware on a processor, ASIC/FPGA, or dedicated hardware. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

All of the processes described above may be embodied in, and fully automated via, software code modules executed by one or more general purpose or special purpose computers or processors. The code modules may be stored on any type of computer-readable medium or other computer storage device or collection of storage devices. Some or all of the methods may alternatively be embodied in specialized computer hardware.

1. A computing device comprising:
input/output (I/O) circuitry;
a memory module configured to store a media player program;
a network interface; and
control circuitry coupled to the memory module, to the I/O circuitry, and to the network interface, and configured to:
connect to a data storage server over a network connection using the network interface;
send a first request to the data storage server for a video file, the first request including a first timestamp parameter indicating a first time associated with the video file;
receive a first live-transcoded video stream from the data storage server, the first live-transcoded video stream corresponding to the first time;
present, using the I/O circuitry, a video presentation interface associated with the media player program without a native seek bar element associated with the media player program;
present, using the I/O circuitry, the first live-transcoded video stream in a video display window of the video presentation interface;
present, using the I/O circuitry, a custom seek bar;
receive seeking input associated with the custom seek bar using the I/O circuitry, the seeking input indicating a second time associated with the video file; and
send, to the data storage server, a second request including a second timestamp parameter indicating the second time.

2. The computing device of claim 1, wherein the control circuitry is further configured to hide the native seek bar element.

3. The computing device of claim 2, wherein the control circuitry is further configured to hide the native seek bar element by initiating the media player program without controls.

4. The computing device of claim 1, wherein the control circuitry is further configured to draw the custom seek bar in the video display window of the video presentation interface.

5. (canceled)

6. The computing device of claim 1, wherein the first time is associated with a start time of the video file.

7. (canceled)

8. The computing device of claim 1, wherein the control circuitry is further configured to:
request a file list from the data storage server; and
determine a location of the video file based on the file list;
wherein the first request and the second request both further include the location of the video file.

9. A network-attached storage device (NAS) comprising:
a non-volatile memory module configured to store a video file;
a network interface; and
control circuitry coupled to the non-volatile memory module and to the network interface and configured to:
connect to a client over a network connection using the network interface;
receive a first request for the video file from the client, the first request including a first timestamp parameter indicating a first time associated with the video file;
retrieve at least a portion of the video file from the non-volatile memory module;
live-transcode a first portion of the video file starting at the first time of the video file that corresponds to the first timestamp parameter to generate a first live-transcoded video stream;
send the first live-transcoded video stream to the client;
receive a second request for the video file from the client, the second request including a second timestamp parameter indicating a second time associated with the video file;
live-transcode a second portion of the video file starting at the second time of the video file that corresponds to the second timestamp parameter to generate a second live-transcoded video stream; and
send the second live-transcoded video stream to the client.

10. The NAS of claim 9, further comprising hardware transcoder circuitry, wherein the control circuitry is further configured to generate the first live-transcoded video stream and the second live-transcoded video stream at least in part using the hardware transcoder circuitry.

11. The NAS of claim 9, wherein the control circuitry is further configured to, in response to the first request, initiate a first transcoder process, wherein said live-transcoding the portion of the video file is directed at least in part by the first transcoder process.

12. The NAS of claim 11, wherein the control circuitry is further configured to, in response to the second request:
end the first transcoder process; and
initiate a second transcoder process.

13. The NAS of claim 9, wherein the NAS does not maintain pre-transcoded video data associated with the video file.

14. A method of presenting video content to a user, the method comprising:
connecting a computing device to a data storage server over a network connection using a network interface of the computing device;
sending a first request to the data storage server for a video file using the network interface, the first request including a first timestamp parameter indicating a first time associated with the video file;
receiving a first live-transcoded video stream from the data storage server, the first live-transcoded video stream corresponding to the first time;
initiating a media player program stored in a memory module of the computing device without a native seek bar element associated with the media player program;
presenting, to a user using input/output (I/O) circuitry of the computing device, the first live-transcoded video stream in a media presentation interface associated with the media player program;
presenting a custom seek bar to the user using the I/O circuitry;
receiving, from the user using the I/O circuitry, seeking input associated with the custom seek bar, the seeking input indicating a second time associated with the video file; and
sending, to the data storage server, a second request including a second timestamp parameter indicating the second time.

15. (canceled)

16. The method of claim 14, wherein said initiating the media play program without the native seek bar element comprises initiating the media player program without controls.

17. The method of claim 14, further comprising drawing the custom seek bar in the media presentation interface.

18. (canceled)

19. The method of claim 14, wherein the first time is associated with a start time of the video file.

20. (canceled)
